(19) United States
(12) Patent Application Publication
(10) Pub. No.: US 2025/0022028 A1
(43) Pub. Date: Jan. 16, 2025

(54) GENERATIVE ARTIFICIAL INTELLIGENCE CODE LOOKUP ENGINE IN AN ITEM LISTING SYSTEM

(71) Applicant: eBay Inc., San Jose, CA (US)

(72) Inventors: Richard Vance SIPE, III, Lufkin, TX (US); Corey Alan SPRAGUE, Hillsboro, OR (US); Nickalas N. BRADSHAW, Tigard, OR (US); Maksim ZADORSKII, Portland, OR (US); Nan ZHANG, Portland, OR (US)

(21) Appl. No.: 18/397,943

(22) Filed: Dec. 27, 2023

Related U.S. Application Data
(60) Provisional application No. 63/513,346, filed on Jul. 12, 2023.

(51) Int. Cl. G06Q 30/0601; G07C 5/08

(52) U.S. Cl. CPC G06Q 30/0625; G06Q 30/0631; G07C 5/0808

(57) ABSTRACT

Methods, systems, and computer storage media for providing generative artificial intelligence (AI) code lookup management using a generative AI code lookup engine in an item listing system. A generative AI code lookup engine supports generative AI code lookup management based on an automotive code lookup platform including code lookup training operations, code lookup engine operations, and code lookup interfaces associated with a generative AI model and an automotive domain for improved personalization and presentation of code lookup data and interfaces. In operation, a request associated with a diagnosis code of a vehicle is accessed. Based on the request, code lookup data associated with a generative AI model is accessed. The generative AI model is associated with code lookup training operations and a code lookup data structure that support code lookup guidance in the item listing system. The code lookup data is communicated for display via an item listing system client.

### CROSS-REFERENCE TO RELATED APPLICATIONS

This application claims the benefit of U.S. Provisional Application No. 63/513,346, filed on Jul. 12, 2023, the entire contents of which are incorporated herein.

### BACKGROUND

Users can interact with generative artificial intelligence technologies in different types of applications and services to accomplish computing tasks. Generative AI refers to a class of AI systems and algorithms that are designed to generate new data or content that is similar to, or in some cases, entirely different from data they are trained on. Generative AI systems can create support text generation, image generation, music and audio generation, video generation and data synthesis. In particular, generative AI systems can support an item listing system in several ways to improve operational efficiency, customer engagement, and online shopping. For example, an item listing system may employ a generative AI system for content generation (e.g., product descriptions); personalized shopping experiences (e.g., code lookup engines); product discovery (e.g., visual search); and virtual assistants (e.g., chat bots). The item listing system can leverage generative AI through Application Programming Interfaces (APIs), pre-trained models, and custom AI solutions to enhance item listing system functionality.

### SUMMARY

Various aspects of the technology described herein are generally directed to systems, methods, and computer storage media for, among other things, providing generative AI code lookup management using a generative AI code lookup engine in an item listing system. A generative AI engine supports generative AI code lookup management based on an automotive code lookup platform including code lookup training operations, code lookup engine operations, and code lookup interfaces associated with generative AI model (e.g., image generation models and Large Language Models “LLMs”) and an automotive domain of an item listing system. In particular, the generative AI code lookup engine provides generative AI code lookup engine operations (“code lookup engine operations”) for the automotive domain including training, generating, deploying, predicting, and controlling operations that are employed—in combination with automotive domain data—to improve code lookup interfaces in an item listing system.

In operation, a request associated with a diagnosis code of a vehicle associated with an item listing system. Based on the request, code lookup data associated with a generative AI model and user data is accessed. The generative AI model is associated with code lookup training operations and a code lookup data structure that support providing code lookup guidance in the item listing system. The generative AI model is associated with historical item listing system automotive data and code lookup logic that support generating and presenting instances of code lookup data for code lookup interfaces. The code lookup data is communicated to cause display of the code lookup data via an item listing system client having a code lookup interface. A code (e.g., a DTC code, or Diagnostic Trouble Code) can be associated with a standardized system for automobiles to identify and communicate issues or malfunctions within a vehicle's systems. These a computer system associated with a vehicle to monitor and control various aspects of the vehicle's performance. When the computer system detects a problem, it stores a code that corresponds to a specific issue or fault.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an artificial intelligence system for providing generative AI code lookup management in an item listing system, in accordance with aspects of the technology described herein;

FIGS. 1C and 1D are interfaces of an artificial intelligence system for providing generative AI code lookup management in an item listing system, in accordance with aspects of the technology described herein;

FIG. 2A is a block diagram of an artificial intelligence system for providing generative AI code lookup management in an item listing system, in accordance with aspects of the technology described herein;

FIG. 2B is a block diagram of an artificial intelligence system for providing generative AI code lookup management in an item listing system, in accordance with aspects of the technology described herein;

FIG. 3 provides a first exemplary method of providing generative AI code lookup management in an item listing system, in accordance with aspects of the technology described herein;

FIG. 4 provides a second exemplary method of providing generative AI code lookup management in an item listing system, in accordance with aspects of the technology described herein;

FIG. 5 provides a third exemplary method of providing generative AI code lookup management in an item listing system, in accordance with aspects of the technology described herein

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California. An item listing system may also provide generative-AI-supported applications (“generative AI applications”) that leverage generative AI models (e.g., image generation models and Large Language Models—“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various tasks across different domains to provide improvement in automation, efficiency, and human-like interaction.

Conventionally, item listing systems are not configured with a comprehensive logic and infrastructure to effectively provide generative AI code lookup management based on automotive domain data of an item listing system. A code lookup system—without generative AI functionality—can lack contextual understanding that impedes the system's ability to grasp the nuanced conditions surrounding a given code, potentially leading to less accurate diagnoses. This shortfall becomes particularly apparent when dealing with ambiguous codes, as the system lacks the capacity to navigate multiple interpretations effectively. Additionally, non-generative systems often face challenges in adapting to evolving standards, new codes, or shifts in diagnostic protocols, resulting in the dissemination of outdated information. Moreover, constrained problem-solving flexibility, reliance on predefined rules, and difficulty in handling uncommon or emerging issues further highlight the limitations of not having generative AI capabilities. As such, a more comprehensive item listing system—with an alternative basis for performing item listing system code lookup engine operations—can improve computing operations and interfaces that provide generative AI code lookup management in an item listing system.

Embodiments of the present invention are directed to systems, methods, and computer storage media for, among other things, providing generative AI code lookup management using a generative AI code lookup engine in an item listing system. A generative AI engine supports generative AI code lookup management based on an automotive code lookup platform including code lookup training operations, code lookup engine operations, and code lookup interfaces associated with generative AI model (e.g., image generation models and Large Language Models “LLMs”) and an automotive domain of an item listing system. In particular, the generative AI code lookup engine provides generative AI code lookup engine operations (“code lookup engine operations”) for the automotive domain including training, generating, deploying, predicting, and controlling operations that are employed—in combination with automotive domain data—to improve code lookup interfaces in an item listing system. Generative AI code lookup management is provided using the generative AI code lookup engine that is operationally integrated into the item listing system associated with an artificial intelligence security system. The artificial intelligence security system supports an automotive code lookup platform framework of computing components associated with code lookup engine operations for providing generative AI code lookup management.

At a high level, the generative AI code lookup engine can be an artificial intelligence code lookup engine. By way of context, a code can refer to a DTC, where DTC stands for Diagnostic Trouble Code. These codes are used in the automotive industry to identify and diagnose issues in a vehicle's systems. When a problem is detected by the onboard diagnostics system (OBD), a DTC is generated and stored. Mechanics and technicians can use specialized diagnostic tools to retrieve these codes and troubleshoot the specific issue. DTC codes are standardized and follow a specific format. The codes are typically alphanumeric, consisting of a letter followed by four numbers (e.g., P0123). Each code corresponds to a specific problem or malfunction in the vehicle. There are different categories of DTCs, and they can relate to various systems, including the engine, transmission, emissions, and more.

By way of illustration, code look-up can be performed in a number of scenarios. For example, a user (e.g., a customer) may have a check engine light code (i.e., engine code or diagnosis code), but not know how to fix it. The customer may identify the check engine light code using a code reader, but not know what the code means. DTCs for vehicles, can be valuable tools for understanding and diagnosing issue.

A code lookup system, though a valuable resource for decoding Diagnostic Trouble Codes (DTCs) in automotive diagnostics, is not without its limitations. As such, a generative AI code lookup engine and code lookup interfaces can be provided to support looking up the code and returning a description of a likely cause. The generative AI code lookup engine can further include machine learning models (e.g., generative AI models) and logic that support generating an estimated of the effort needed to perform a repair. The effort may be associated with a scale (e.g., easy, normal, and difficult). The generative AI code lookup engine can further estimate the cost (e.g., use product cost range), and show possible products with listing needed to repair that item. The generative AI code lookup engine can also include a link to “Ask an Expert”.

In this way, the item listing system—via a generative AI code lookup engine—with an extensive repository of historical data (e.g., historical automotive data in an item listing system) on customer interactions with Diagnostic Trouble Codes (DTCs) can leverage the power of generative AI to significantly enhance its code lookup management and functionality. By dissecting the patterns within this historical data, the generative AI can offer nuanced interpretations of DTC codes, going beyond mere identification to provide context-aware insights into the underlying vehicle issues. This depth of understanding enables the generative AI code lookup engine to estimate the effort required for repairs and predict associated costs by considering historical data on repair procedures, part availability, and past repair times for similar DTCs. Furthermore, the generative AI, enriched by insights from customer purchasing behavior related to specific DTCs, can recommend and showcase relevant products, from replacement parts to tools, tailored to address the identified automotive issues.

The benefits of integrating generative AI in this automotive vertical are diverse. Not only does it enhance accuracy in interpreting DTCs and estimating repair parameters, but it also introduces a layer of personalization by tailoring recommendations based on individual user profiles and historical interactions. The continuous learning capability of generative AI ensures adaptability to changing automotive trends and emerging issues, keeping the system up-to-date. This, in turn, fosters user engagement, satisfaction, and trust in the item listing system, as users experience a seamless and personalized journey from DTC diagnosis to product recommendations and expert assistance.

As such, the generative AI code lookup engine can be provided to support presenting images (i.e., image data) and text (i.e., text data) employing generative AI models (e.g., image generation models and LLMs) in an item listing system. The generative AI code lookup engine can be an automotive code lookup solution that provides generative AI code lookup engine operations and a code lookup data structure associated with providing generative AI code lookup management for different code lookup interfaces. The code lookup solution addresses limitations with traditional code lookup technology and includes development of generative AI code lookup functionality that improve the functioning of an item listing system.

The generative AI code lookup engine is responsible for providing generative AI image data or text data. In particular, the generative AI code lookup provides composite image data that includes an image that is created by combining and layering multiple individual images and text elements or visual components. Composite image data can be created by combining photographs, graphics, illustrations, text or other visual elements to form a single, cohesive image. The composite image data can include non-generative AI data elements and generative AI data elements. The non-generative AI data elements can include pre-existing images or text that are not generated via the generative AI model, while generative AI elements include images or text that are originally created using the generative AI model.

The composite image data can include generative AI image elements and generative AI item listing interface elements. The generative AI images elements can include different types of images (e.g., AI images and non-AI images) that are part of the composite image and the generative AI item listing interface elements can includes item listing features (e.g., text, price, title, descriptions, filters, buttons, color pallets, and actions) that are part of the generative composite image. The generative AI code lookup engine can include additional features associated with the images. For example, the generative AI code lookup engine can support text descriptions for image sets or each image in the image set. The text descriptions may include generative AI text descriptions that provide additional insights (e.g., product highlights) associated with a product in the image and the user. The generative AI code lookup engine can include image sets associated with a user. The image sets can include actual images associated with the user or generative AI images generated based on features (e.g., historical interactions, purchases, images, etc.) associated with the user.

The generative AI code lookup engine can implement a code lookup data structure that supports storing and providing code lookup data. For example, the code lookup data structure can be a linked data structure of related images and text and sets of images and text that are configured to be presented on different code lookup data interfaces. The code lookup data structure can be associated with code lookup logic associated with identifying and presenting code lookup data. The code lookup logic can be generated via training operations associated with the generative AI model. In this way, the automotive code lookup data can be provided based on code lookup interfaces.

The generative AI code lookup engine provides training operations and a code lookup data structure to support providing generative AI code lookup management. Code lookup training operations can refer to machine learning training operations that are associated with training data, code lookup data, item listing interfaces (e.g., different configurations of item listing interfaces) and corresponding functionality and services. Code lookup training operations and code lookup logic as associated with the code lookup process for automotive diagnostics, users input a specific Diagnostic Trouble Code (DTC), sourced from their vehicle's onboard diagnostic system. The generative AI code lookup engine retrieves and categorizes relevant historical data associated with the entered DTC, encompassing a database of past instances with similar codes and their resolutions. This categorized historical data, spanning DTC meaning, estimated repair effort, estimated cost, and product recommendations, is subjected to analysis by a generative AI model trained on this dataset. The generative AI model is equipped to discern patterns and correlations, generates context-aware insights. These insights, ranging from detailed DTC explanations to estimates for repair efforts and costs, are presented to the user in a user-friendly interface. The system's continuous learning mechanism incorporates user interactions and feedback, refining the generative AI model over time. Optionally, the generative AI code lookup engine can integrate with external systems like repair manuals or e-commerce platforms to enrich the information provided. This comprehensive approach facilitates informed decision-making for users grappling with automotive DTCs, ensuring accurate, personalized, and continually improving diagnostic insights.

As such, the generative AI code lookup engine supports looking up the code and returning a description of a likely cause. Interfaces associated with the generative AI code lookup engine can be provided based on machine learning models. For example, a machine learning model can support generating an estimate of an effort need to perform a repair associated with a code, where the effort can be associated with a complexity scale (e.g., easy, normal, difficult); generating an estimate cost (e.g., product cost range); or generating recommended products needed for the repair. The interfaces can also be associated with an Ask an Expert link that navigates to an interface to communicate with an expert about the code and the above-identified additional information.

Advantageously, the embodiments of the present technical solution support providing generative AI code lookup management using a generative AI code lookup engine in an item listing system. A generative AI code lookup engine supports generative AI code lookup based on an automotive code lookup platform and a code lookup data structure for code lookup guidance associated with generative AI models (e.g., image generation models and LLMs) and item listing system interfaces. The generative AI code lookup engine operations provide a solution to problems (e.g., adapting to evolving standards, new codes, or shifts in diagnostic protocols, resulting in the dissemination of outdated information) in generative AI code lookup management. The generative AI code lookup engine components, infrastructure, and ordered combination are an improvement over conventional item listing systems that lack support for generative AI code lookup management.

In this way, the technical solution provides specific technological advancement because the use of generative AI for diagnosis code identification represents a specific implementation that enhances the functioning of computers within the automotive diagnostics domain. The use of the generative AI code lookup engine imparts a novel and specific advancement by improving the accuracy and efficiency of diagnosis code identification.

The technical solution also provides accurate and prompt identification of diagnosis code, and the generative AI code lookup engine introduces a concrete solution by employing sophisticated algorithms and data processing steps. The generative AI's ability to adapt and learn from new data, providing dynamic and personalized diagnosis code recommendations, and the inclusion of advanced machine learning algorithms and real-time adaptation features distinguishes the claim from generic business methods and positions it as a technologically progressive solution.

Moreover, the generative AI model provides improved user interfaces for understanding and addressing diagnosis codes. Traditional methods for diagnosing issues often involved convoluted user interfaces, and the use of generative AI streamlines this process, presenting diagnosis code information in an intuitive manner. For example, the generative AI-driven interface enhances user-friendliness in navigating complex vehicle issues by providing a specific and user-friendly manner of presenting the diagnosis codes. The technical solution introduces a specific and innovative manner of summarizing and presenting this diagnosis code information, making the diagnostic process more accessible and efficient. By incorporating generative AI, the interface offers not only DTC identification but also actionable recommendations, elevating the user experience and problem-solving capabilities, thus enhancing the overall user experience.

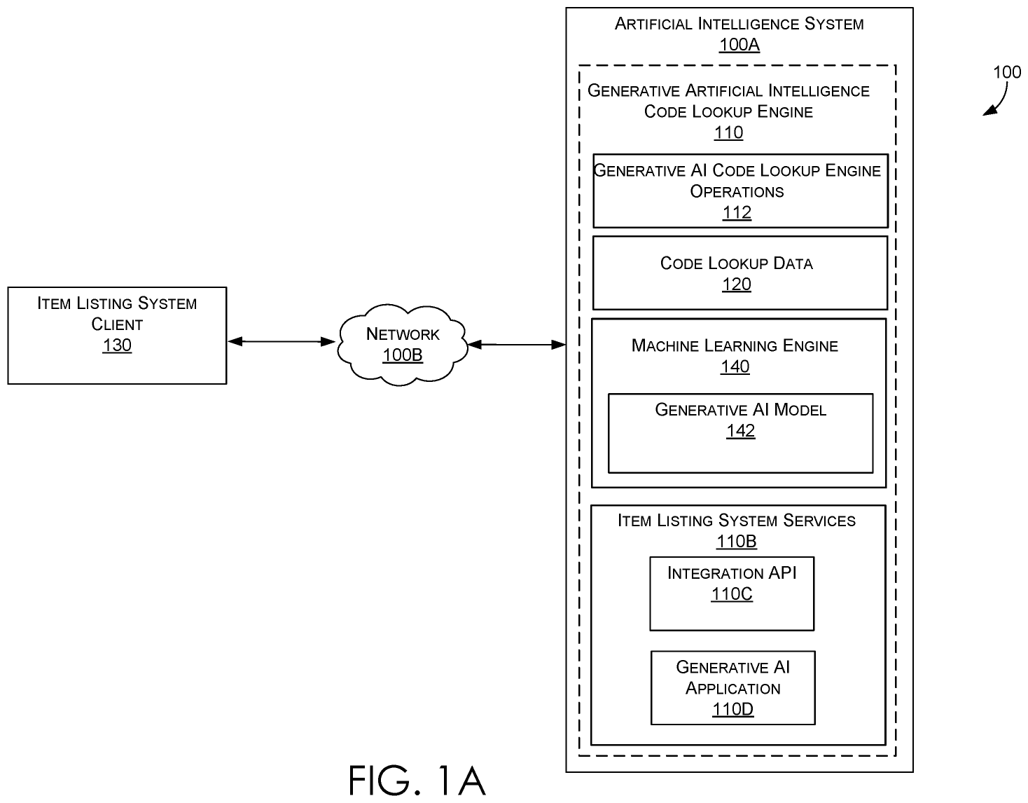

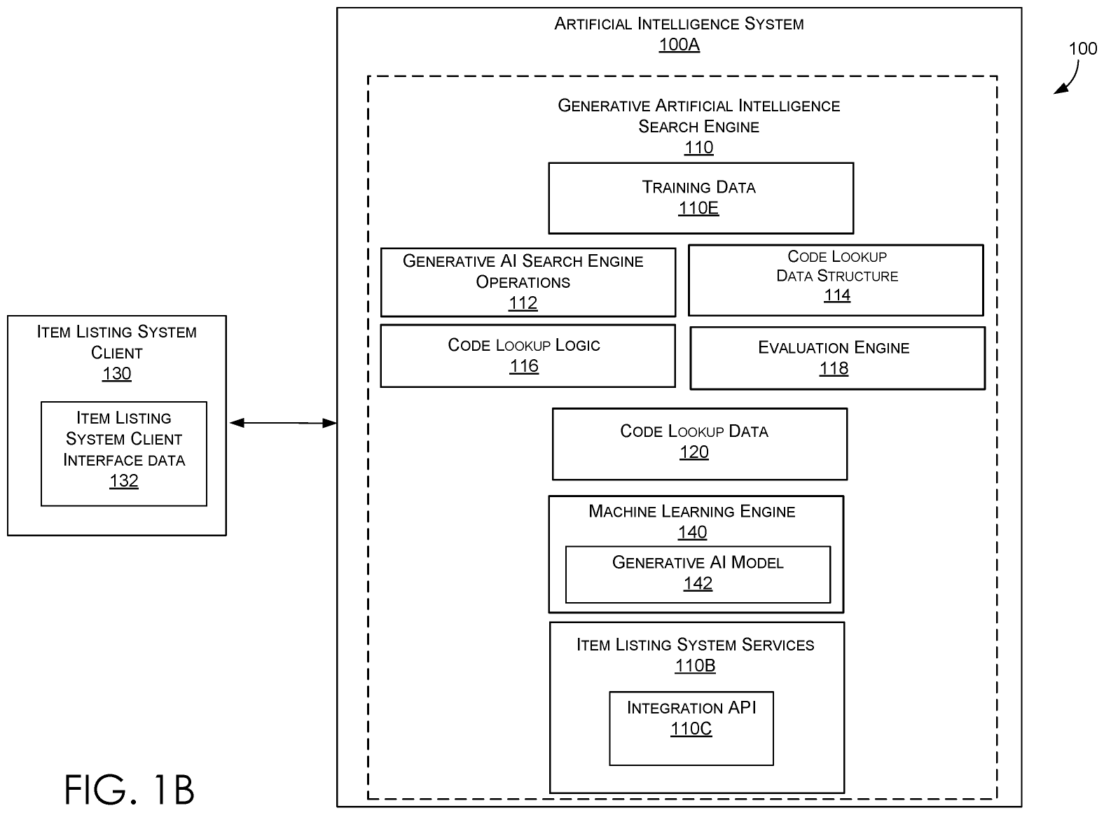

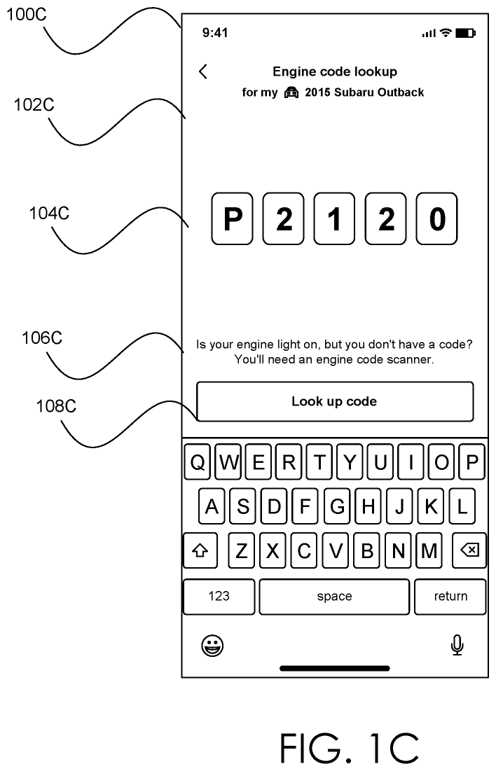

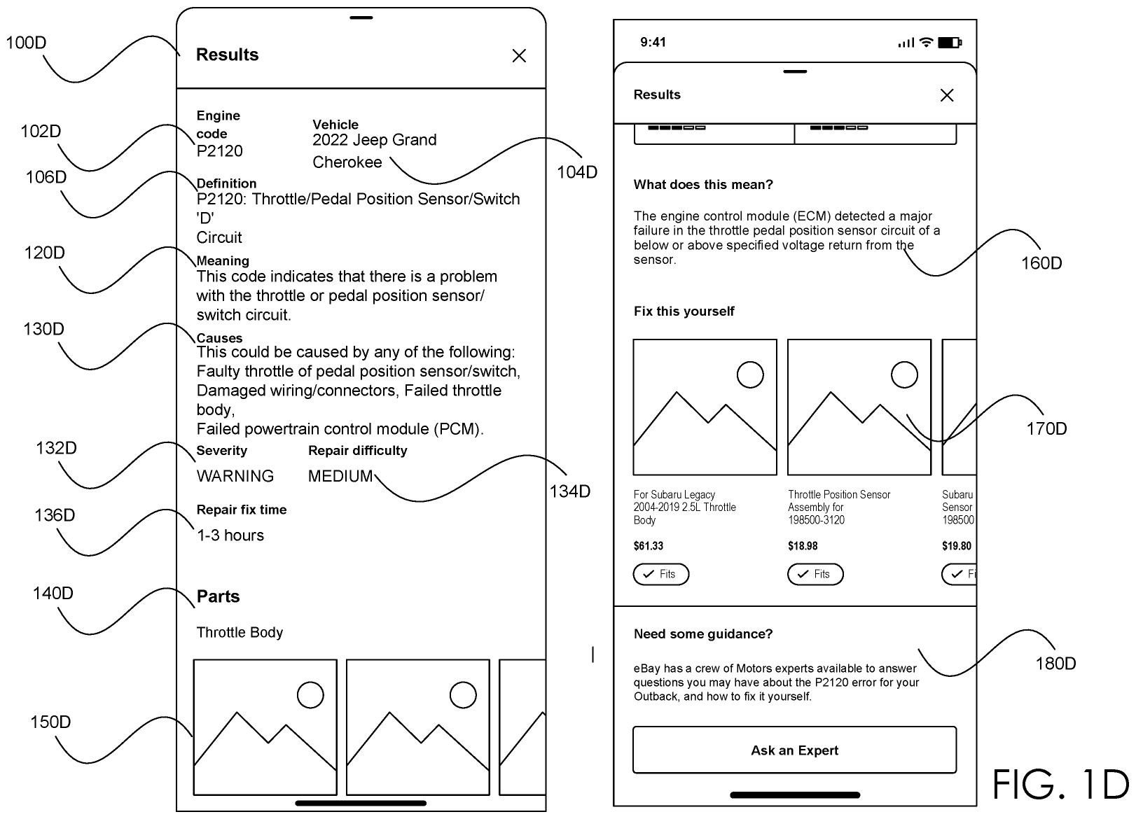

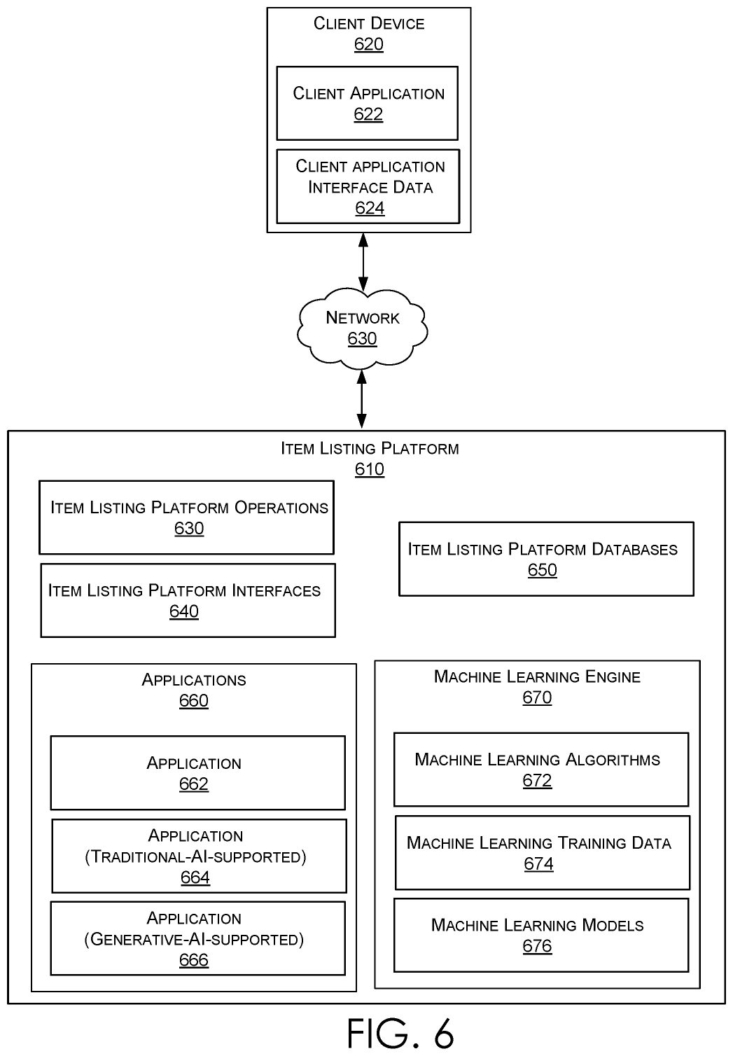

Aspects of the technical solution can be described by way of examples and with reference to FIGS. 1A-1D. FIG. 1A illustrates an item listing system 100 that includes artificial intelligence system 100A, network 100B, generative artificial intelligence (AI) code lookup engine 110, item listing system services 110B, integration API 110C, generative AI application 110D, generative AI code lookup engine operations 112, code lookup data 120, item listing system client 130, machine learning engine 140 including generative AI model 142. The item listing system 100 corresponds to item listing system 600 described below with reference to FIG. 6.

The item listing system 100 provides a system (e.g., artificial intelligence “AI” system 100A) that includes an engine (e.g., generative AI code lookup engine 110) for performing operations (e.g., generative AI code lookup engine operations 112) discussed herein. For example, the generative AI code lookup engine 110 employs the generative AI model 142 to generative code lookup data 120 that support providing automotive upgrade guidance. The generative AI code lookup engine 110 can also operate with the item listing system client 130 (e.g., a client device or generative AI application client) that can access the item listing system 100 to execute tasks using item listing system services 110D (e.g., generative AI application 110D) associated with a corresponding generative AI model 142. For example, a user—via the item listing system client 130 (e.g., a prompt interface)—can communicate a request (e.g., a generative AI request having prompt data) to the generative AI application 110D and the generative AI model 142—associated with the machine learning engine 140—to process the request. Based on the communicating the request, the generative AI code lookup engine 110 can execute generative AI code lookup engine operations (e.g. training, generating, deploying, integrating, predicting, and controlling operations) with components of the generative AI code lookup engine 110—to ensure processing the request.

The generative AI code lookup engine 110 can further include item listing system services 110B that correspond to different services of the item listing system. The item listing system services can include search services and recommendation services, for example, that employ the code lookup data 120 to provide item listing system functionality. Item listing system services can include generative AI code lookup management associated with the item listing system 100. Integration Application Programming Interface (API) 110C can be provided to integrate the item listing system services with the automotive code lookup data 120. Generative AI application 110D may also operate to employ the automotive code lookup data 120 to provide functionality associated with the generative AI application 110D. Other variations and combinations of item listing system services are contemplated with embodiments described herein.

With reference to FIG. 1B, FIG. 1B illustrates an artificial intelligence system 100A, generative AI code lookup engine 110, training data 110E, generative AI code lookup engine operations 112, code lookup data structure 114, code lookup logic 116, evaluation engine 118, code lookup data 120, item listing system client 130, item listing system client interface data 132, machine learning engine 140, and generative AI model 142.

The generative AI code lookup engine 110 and the item listing system client 130 provide graphical user interfaces (e.g., item listing system interfaces and generative AI application interfaces) and operations (i.e., generative AI code lookup engine operations 112). The generative AI code lookup engine 110 and the item listing system client 130 can operate in a server-client relationship to provide generative AI code lookup management functionality. For example, a user can communicate a request from the item listing system client 130 to execute a task via the generative AI code lookup engine 110 using a diagnosis code. Based on the request, the generative AI code lookup engine 110 can perform generative AI code lookup engine operations 112 to ensure processing of the request in the artificial intelligence system 100A.

The generative AI code lookup engine 110 may execute generative AI code lookup engine operations 112 to provide functionality associated with generating, deploying, integrating, and using the code lookup data 120. The generative AI code lookup engine can employ the generative AI model (e.g., an LLM) to generate code lookup data.

The generative AI code lookup engine 110 may execute generative AI code lookup engine operations 112 to provide functionality associated with generating, deploying, integrating, and using the code lookup data 120. The generative AI code lookup engine can employ the generative AI model (e.g., an LLM) to generate code lookup data.

The generative AI code lookup engine 110 can be built on different types of automotive data (e.g., training data 110E) associated with code lookup interfaces associated with a generative AI model and an automotive domain for improved personalization and presentation of code lookup data and interfaces in the item listing system 100. Types of automotive data can include vehicle specifications, such as, details about the make, model, year and specific features of the user's vehicle. Maintenance and service history of the user and vehicles including information on past maintenance activities, service records, and repairs. Purchase history including previous upgrades, accessories, or products purchased for the vehicles. User preferences including individual preferences such as brands, styles, and types of upgrades. Driving patterns including data on driving habits, terrain, and environmental conditions.

The generative AI code lookup engine can support prompt engineering for generative AI code lookup management. Prompt engineering for automotive recommendations involves crafting input queries or instructions that guide generative AI models to produce relevant and accurate suggestions in the automotive domain. Considerations include ensuring diagnostic codes and automotive data are captured for each query. Integration of vehicle specifications, including make, model, and year, is crucial for tailoring recommendations to the user's unique automotive context. Designing prompts to elicit information about user preferences facilitates alignment with personal taste.

Historical behavior reflection prompts encourage the AI to consider the user's past upgrades and interactions, aligning recommendations with evolving preferences. Visual representation requests instruct the AI to generate simulations of upgrades on the user's specific vehicle, enhancing the decision-making process. Trend identification queries ensure recommendations stay current with industry trends. Dynamic adaptation instructions support personalized and evolving recommendations based on changes in user behavior. Comparative analysis prompts enable users to explore upgrade options, aiding decision-making. Privacy and data sensitivity instructions address user privacy concerns during recommendation generation. Creative exploration prompts encourage the AI to suggest unique upgrades, inspiring users with innovative recommendations. User engagement and call-to-action prompts foster interaction, while multimodal input considerations allow users to provide a more comprehensive understanding of preferences.

The generative AI model 142 can support generating code lookup data 120. The generative AI model supports dissecting the patterns within this historical data, the generative AI model 142 can offer nuanced interpretations of DTC codes, going beyond mere identification to provide context-aware insights into the underlying vehicle issues. This depth of understanding enables the generative AI code lookup engine 110 to estimate the effort required for repairs and predict associated costs by considering historical data on repair procedures, part availability, and past repair times for similar DTCs. Furthermore, the generative AI, enriched by insights from customer purchasing behavior related to specific DTCs, can recommend and showcase relevant products, from replacement parts to tools, tailored to address the identified automotive issues.

Automotive personalization data 120 can include inspirational automotive personalization data based on trend analysis and visual content generation. With trend analysis the generative AI model 142 can analyze historical data to identify trends in popular upgrades or modifications within a specific vehicle category. This information can inspire uses by showcasing trending accessories or enhancements. The generative AI model 142 can create visually appealing content, including images and videos demonstrating how certain upgrades or accessories would look on the user's specific vehicle model.

The generative AI model 142 can also provide code lookup data 120 based on user behavior prediction, dynamic adaptation, and custom product suggestions. For example, the generative AI model 142 can predict future user behavior based on historical patterns, helping personalize recommendations by suggesting upgrades aligned with the user's preferences and past choices. The generative AI model 142 can adapt recommendations dynamically, considering changes in the user's driving patterns, vehicle specifications, or preferences over time. And, by generating personalized suggestions for accessories or upgrades based on the user's unique vehicle specifications, generative AI enhances the relevance of recommendations.

In this way, the code lookup data 120 can be associated with enhanced personalization, visual simulation, adaptive recommendations, trend identification, and improved user engagement. Enhanced personalized is provided because the generative AI model 142 is capable of understanding complex patterns in user behavior and vehicle data, leading to highly personalized recommendations that align with individual preferences. The generative AI model 142 can simulate visual representations of recommended upgrades on the user's specific vehicle, providing a realistic preview and aiding in the decision making process. The dynamic nature of the generative AI model 142 allows for adaptive recommendations that consider evolving user preferences, ensuring that suggestions remain relevant over time. Moreover, by analyzing historical data, generative AI model 142 can identify emerging trends in the automotive aftermarket, enabling the generative AI code lookup engine 110 to stay ahead of the curve and provide users with cutting-edge recommendation. And, the ability to generate visually compelling content and personalized suggestions enhances user engagement, encourages user to explore and consider upgrading their vehicles.

The generative AI model 142 can further be configured to generate automotive personalization data including personalized copy, personalized upgrade guides, and personalized upgrade products. For example, code lookup data 120 can include insights that focus on human-like text or images that inspirational or recommendations. The generative AI model 142 can personalized copy for upgrade guides to tailor the content to the specific needs, preferences, and characteristics of an individual user and their vehicle. It goes beyond generic recommendations, providing targeted advice and suggestions based on the user's unique profile. The goal is to create a customized and engaging experience that resonates with the user's interests and requirements. The generative AI model 142 can draft coherent narratives summarizing overall user experiences, identifying recurring themes, and generating custom tags or labels for reviews. The generative AI models can contribute to trend identification, pinpointing emerging patterns in user feedback, and can provide nuanced insights into contextual product usage.

By way of illustration, an upgrade guide for a vehicle can serve as a comprehensive resource offering recommendations to vehicle owners seeking to enhance or modify their vehicles. This guide encompasses a spectrum of information on diverse upgrades, modifications, and accessories aimed at improving the vehicle's performance, aesthetics, functionality, and overall driving experience. Key components of the guide include suggestions for performance enhancements, aesthetic upgrades, interior modifications, improvements in suspension and handling, safety and lighting enhancements, technology integrations, off-road modifications, fuel efficiency improvements, maintenance tips for longevity, regulatory compliance considerations, and budget-conscious options. The guide is designed to empower vehicle owners with the knowledge needed to make informed decisions about customizing their vehicles based on personal preferences and needs. Presented in various formats such as written guides, online resources, or interactive tools, it serves as a valuable reference for enthusiasts looking to personalize and optimize their vehicles.

The code lookup logic 116 can include systematic analysis of code lookup data 120 to select code lookup data to be communicated for a user. The code lookup logic 116 can be implemented using machine learning models—including generative AI machine learning models—that employ collaborative filtering algorithms or deep learning models to make code lookup data selections. In particular, based on aggregating user preference information and other types of code lookup data 120, the code lookup logic 116 can be used to analyze different code lookup data 120 to make selections.

Item listing system client 130 can be associated with seller interfaces, buyer interfaces, and other item listing system service interfaces associated with the item listing system. The item listing system client 130 can cause display of item listing system client interface data 132 that is associated with items associated with the item listing system 100 based on the generative AI code lookup engine 110, the generative AI model 142, code lookup data 120, and functionality associated with the item listing system 100. The item listing system client interface data 140 can be associated with different outputs corresponding to the item listing system services 110B and other functional components and outputs of the generative AI code lookup engine 110D.

The evaluation engine can be a success measurement engine can is responsible for measuring the success of the generative AI code lookup engine 110. The success measurement engine can operate based on quantitative and qualitative measurements. Quantitative measurements can include codes usage (i.e., number of codes entered and lookup success); suggested part performance (i.e., CTR, BBOWAQ); Ask an Expert (i.e., questions asked, AE performance as measured). Qualitative measurements can include customer feedback (i.e. appetitive survey, reviews/CS feedback).

With reference to FIG. 1C, FIG. 1C illustrates a schematic associated with providing generative AI code lookup management using a generative AI code lookup engine in accordance with embodiments described herein. FIG. 1C illustrates code lookup interface 100C that includes a plurality of interface portions associated with automotive code lookup data and generative AI code lookup management functionality. A diagnosis code lookup header portion 102C can be provided to present the vehicle associated with the diagnosis code. A diagnosis code portion 104C can be provided to receive a diagnosis code on the code lookup interface 100C. Additional interface portions include code lookup information portion 106C and code lookup button 108C. The code lookup information portion can provide general guidance around providing the diagnosis code for processing and the code lookup button 108C can support communicating a diagnosis code for additional processing to generated code lookup data via the generative AI code lookup engine.

With reference to FIG. 1D, FIG. 1D illustrates a schematic associated with providing generative AI code lookup management using a generative AI code lookup engine in accordance with embodiments described herein. FIG. 1D illustrates code lookup interface 100D a plurality of interface portions associated with code lookup data and generative AI code lookup management functionality. The code lookup interface 100D can be a code lookup data results interface associated with providing a diagnosis code to the code lookup interface 100C. A diagnosis code portion 102D can be provided to present the engine code (e.g. P2120); a vehicle portion 104D can be provided to present the vehicle (e.g., 2022 JEEP GRAND CHEROKEE) associated with the request and the diagnosis code. Additional interface portions include definition portion 106D, meaning portion 120D, causes portion 130D, severity portion 132D, repair difficulty portion 134D, report fix time portion 136D, parts text portion 140D, parts image portion 150D, a what does this mean portion 160D, a fix this your portion 170D for text data and image data, and an As an Expert portion 180D include text data and Ask an Expert button. The portions of the code lookup interface can be generated and presented based on code lookup data associated with the diagnosis code. The code lookup data is generated using a generative AI model of the generative AI code lookup engine.

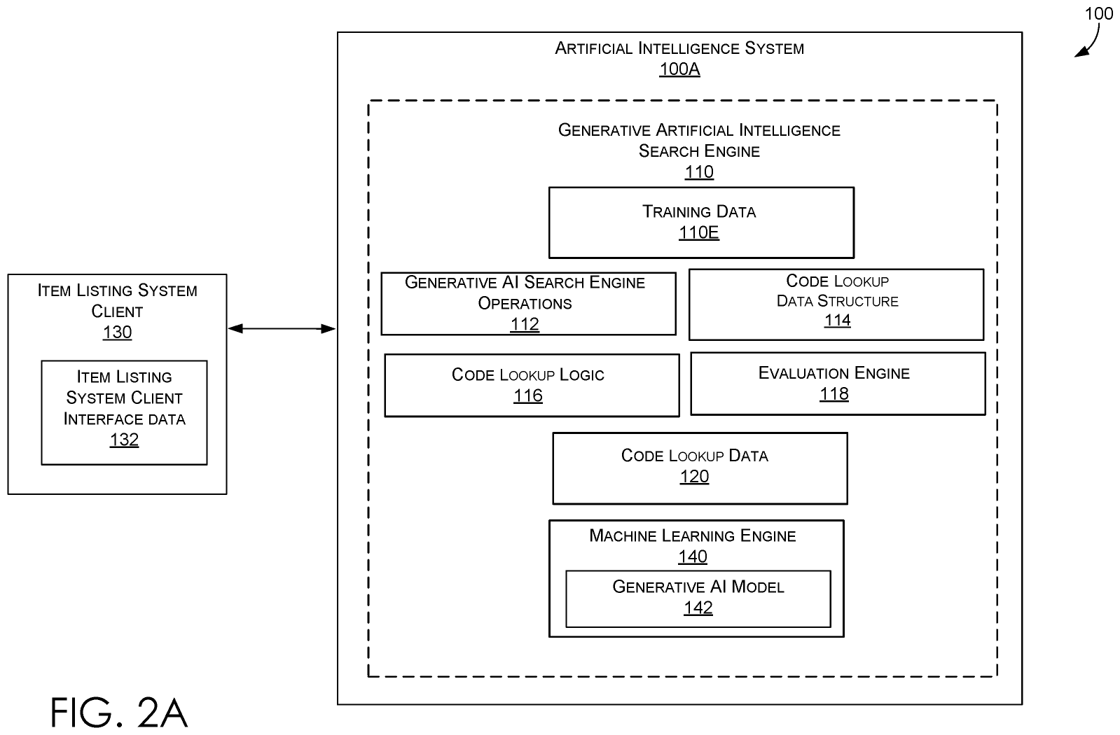

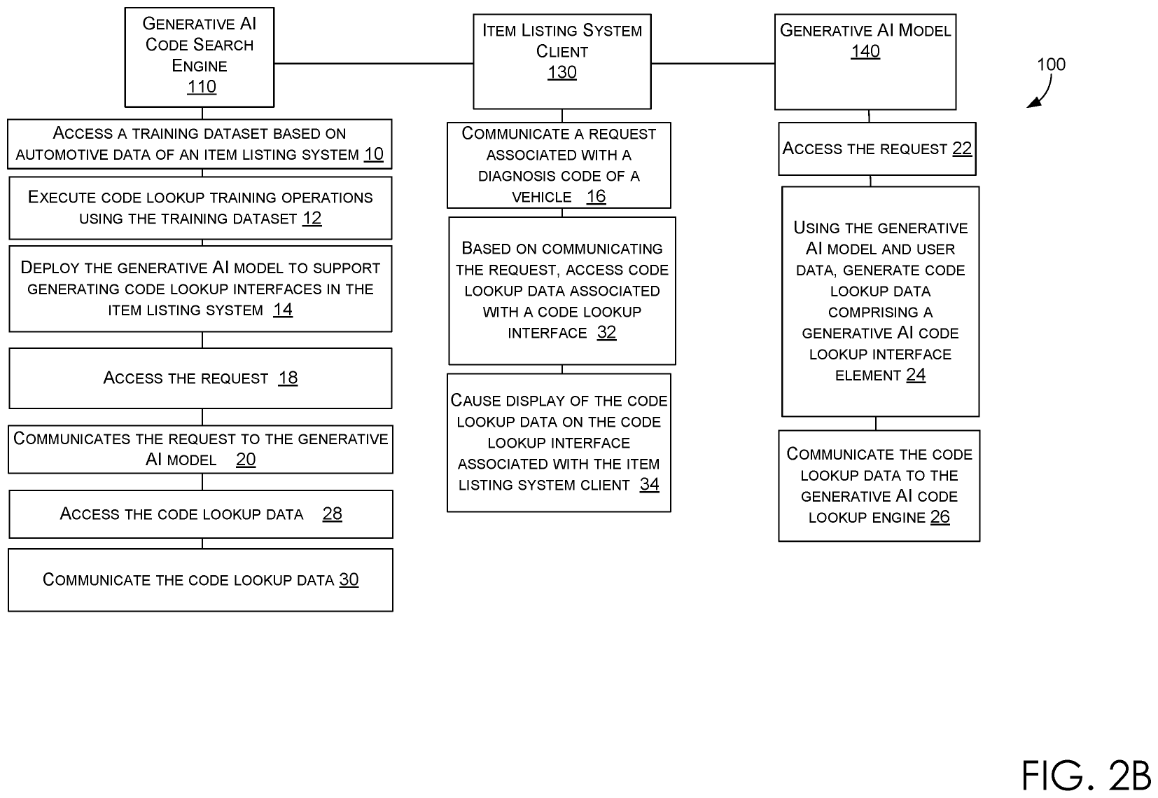

Aspects of the technical solution can be described by way of examples and with reference to FIGS. 2A and 2B. FIG. 2A is a block diagram of an exemplary technical solution environment, based on example environments described with reference to FIGS. 6A, 6B, 7 and 8 for use in implementing embodiments of the technical solution are shown. Generally the technical solution environment includes a technical solution system suitable for providing the example item listing system 100 in which methods of the present disclosure may be employed. In particular, FIG. 2A shows a high level architecture of the item listing system 100 in accordance with implementations of the present disclosure. Among other engines, managers, generators, selectors, or components not shown (collectively referred to herein as “components”), the item list platform system 100 of FIG. 2A corresponds to FIGS. 1A and 1B.

With reference to FIG. 2A, FIG. 2A illustrates an item listing system 100, artificial intelligence system 100A, generative AI code lookup engine 110, training data 110E, generative AI code lookup engine operations 112, code lookup data structure 114, code lookup logic 116, code lookup data 120, item listing system client 130, item listing system client interface data 132, machine learning engine 140, and generative AI model 142.

The item listing system 100 provides the artificial intelligence system 100A and the generative AI code lookup engine 110 to support providing generative AI code lookup management. The generative AI code lookup engine 110 can execute generative AI code lookup engine operations 112 to employ the generative AI model 142 to generate code lookup data 120. The generative AI code lookup engine 110 is associated with the machine learning engine 140 and the generative AI model 142 that supports image generation and text generation for instances of code lookup data.

The generative AI code lookup engine 110 accesses a training data (e.g., training data 110E) associated with training a generative AI model (e.g., generative AI model 142). The code lookup training operations support training generative AI models based on training data 110E that includes user data, automotive data, image data, text data, and item listing interfaces data. The training operations support generating instances of code lookup data for a plurality of item listing interfaces of an item listing system.

The generative AI model 142 is associated with code lookup training operations and an code lookup data structure 114 that support providing automotive diagnosis code guidance the item listing system 100. The code lookup training operations can be based on one or more prompt templates that include structured input queries or instructions designed to train or instruct the generative AI model to generate code lookup data 120. A prompt template can include code lookup data categories including Diagnosis Trouble Code (DTC), additional vehicle information, and historical automotive context.

The code lookup data structure 114 is associated with code lookup logic 116 that includes instructions for providing the code lookup data 120 including diagnosis code meaning, estimated repair cost, estimated cost, one or more recommended items. The generative AI code lookup engine 110 deploys the generative AI model 142 to support generating code lookup data 120 in the item listing system.

The generative AI code lookup engine 110 accesses a request associated diagnosis code of vehicle associated with the item listing system 100. The request can be for data in an item listing system. For example, the request can be associated with a code lookup interface associated with the item listing system. The request can be associated with the code lookup interface that supports presenting code lookup data 120. Based on the request, the generative AI code lookup engine 110 accesses code lookup data 120 associated with the generative AI model 142.

The generative AI code lookup engine 110 uses the generative AI model to generate the code lookup data 120 including diagnosis code meaning, estimated repair cost, estimated cost, one or more recommended items for a code lookup interface for presenting instances of code lookup data for requests processed using the generative AI presentation engine. The automotive code lookup data can include a non-generative AI data element, a generative AI data element, and a generative AI item listing interface element. The generative AI code lookup engine 110 communicates the code lookup data 120 to cause display of the code lookup data 120 via the item listing system client 130.

With reference to FIG. 2B, FIG. 2B illustrates generative AI code lookup engine 110, item listing system client 130, and generative AI model 140 for providing generative AI code lookup management in an item listing system 100. At block 10, the generative AI code lookup engine 110 accesses a training dataset based on automotive data of an item listing system to train a generative AI model; at block 12, executes code lookup training operations using the training dataset to train or instruct the generative AI model; and at block 14, deploys the generative AI model to support generating code lookup interfaces in the item listing system.

At block 16, the item listing system client 130 communicates a request associated with a diagnosis code of a vehicle. At block 18, the generative AI code lookup engine 110 accesses the request; at block 20 communicates the request to the generative AI model 140. At block 22, the generative AI model 140 accesses the request; at block 24, the generative AI model 140 uses the generative AI model 140 and user data to generate code lookup data comprising a generative AI code lookup interface element; and at block 26, communicates the code lookup data to the generative AI code lookup engine.

At block 28, the generative AI code lookup engine 110 accesses the code lookup data; at block 30, communicates the code lookup data to the item listing system client 130 to cause display of the code lookup data. At block 32, the item listing system client 130, based on communicating the request, accesses the code lookup data associated with an code lookup interface; at block 34, causes display of the of the code lookup data on the code lookup interface associated with the item listing system client.

### Example Methods

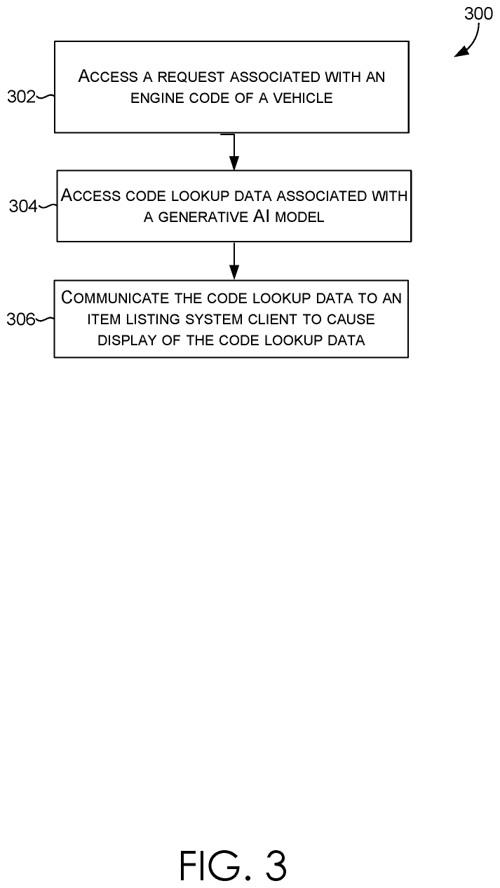

With reference to FIGS. 3, 4, and 5 flow diagrams that illustrate methods for providing generative AI code lookup management using a generative AI code lookup engine in an item listing system. The methods may be performed using the item listing system described herein. In embodiments, one or more computer-storage media having computer-executable or computer-useable instructions embodied thereon that, when executed, by one or more processors can cause the one or more processors to perform the methods (e.g., computer implemented method) in an item listing system (e.g., computerized system or computer system).

Turning to FIG. 3, a flow diagram is provided that illustrates a method 300 for providing generative AI code lookup management using a generative AI code lookup engine in an item listing system. At block 302, the generative AI code lookup engine accesses a request associated a diagnosis code of a vehicle associated with an item listing system. At block 304, the generative AI code lookup engine accesses code lookup data associated with a generative AI model. The generative AI model is associated with code lookup training operations and a code lookup data structure that support providing automotive diagnosis code guidance the item listing system. At block 306, the generative AI code lookup engine communicates the code lookup data to an item listing system client to cause display of the composite image data via the item listing system client.

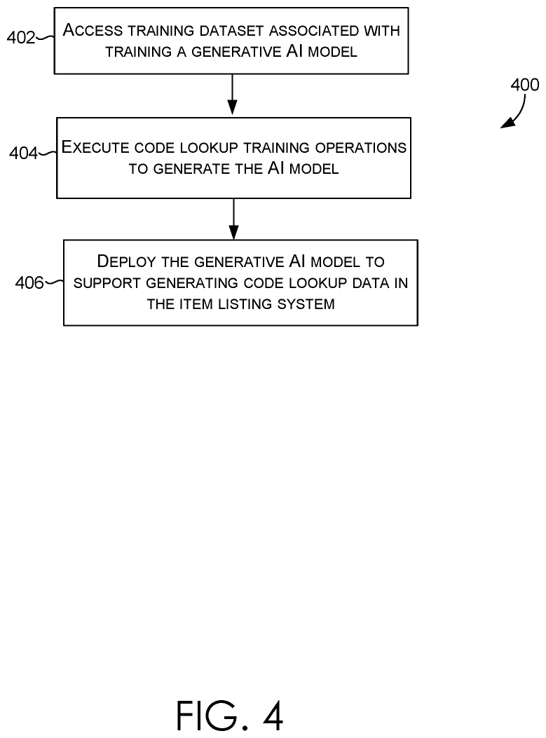

Turning to FIG. 4, a flow diagram is provided that illustrates a method 400 for providing generative AI code lookup management using a generative AI code lookup engine in an item listing system. At block 402, the generative AI code lookup engine accesses a training dataset associated with training a generative AI model. At block 404, the generative AI code lookup engine executes code lookup training operations to generate the AI model. At block 406, the generative AI code lookup engine deploys the generative AI model to support generating code lookup data in an item listing system.

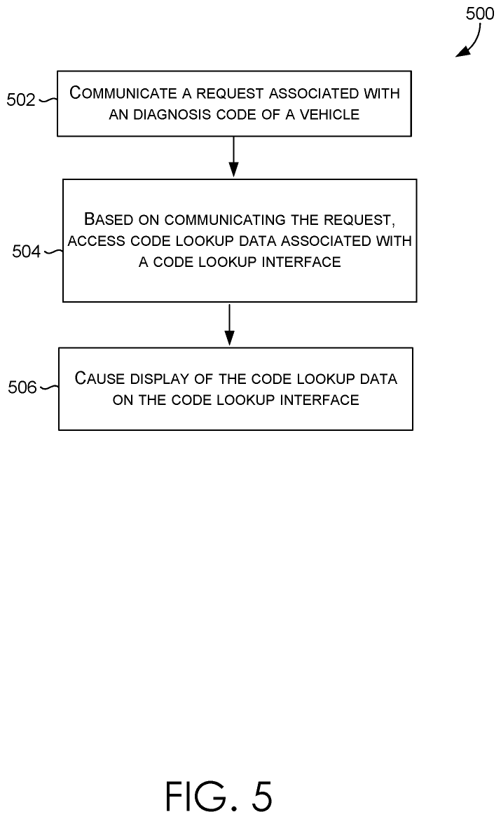

Turning to FIG. 5, a flow diagram is provided that illustrates a method 500 for providing generative AI code lookup engine using a generative AI code lookup engine in an item listing system. At block 502, a generative AI client communicates a request associated a diagnosis code of a vehicles associated with a user of an item listing system. At block 504, based on communicating the request, the generative AI client accesses code lookup data associated with a code lookup interface. At block 506, the generative AI client causes display of the code lookup data on the code lookup interface.

### Technical Improvement

Embodiments of the present invention have been described with reference to several inventive features (e.g., operations, systems, engines, and components) associated with an item listing system. Inventive features described include: operations, interfaces, data structures, and arrangements of computing resources associated with providing the functionality described herein relative with reference to an item listing system.

Embodiments of the present invention relate to the field of computing, and more particularly to item listing systems. The following described exemplary embodiments provide a system, method, and program product to, among other things, execute generative AI code lookup engine operations that provide generative AI code lookup management using a generative AI code lookup engine. Therefore, the present embodiments have the capacity to improve the technical field of item listing system technology by providing more efficient user interfaces. For example, interfaces described for this technical solution provide a specific improvement over prior systems, resulting in an improved user interface for an item listing system. In particular, the particular manner of summarizing and presenting code lookup data do not use conventional user interface methods. The technical solution addresses conventional item listing platforms' lack of integration with a generative AI code lookup engine based on improving item listing system technology by improving user's efficiency in navigating item listing system interfaces.

Functionality of the embodiments of the present invention have further been described, by way of an implementation and anecdotal examples—to demonstrate that the operations for providing generative AI code lookup management using a generative AI code lookup engine in an item listing system as a solution to a specific problem in item listing platform technology to improve computing operations in item listing systems. Overall, these improvements result in less CPU computation, smaller memory requirements, and increased flexibility in item listing systems when compared to previous conventional item listing system operations performed for similar functionality.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 630) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and personalization engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing system's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 120 supports the process of building, training, and fine-tuning machine learning models. Machine learning training data 120 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

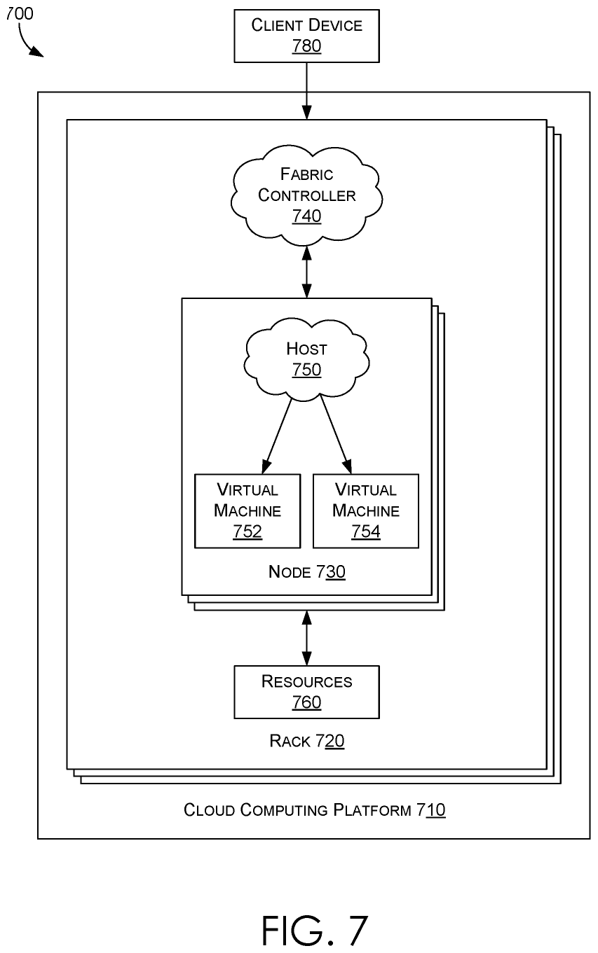

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

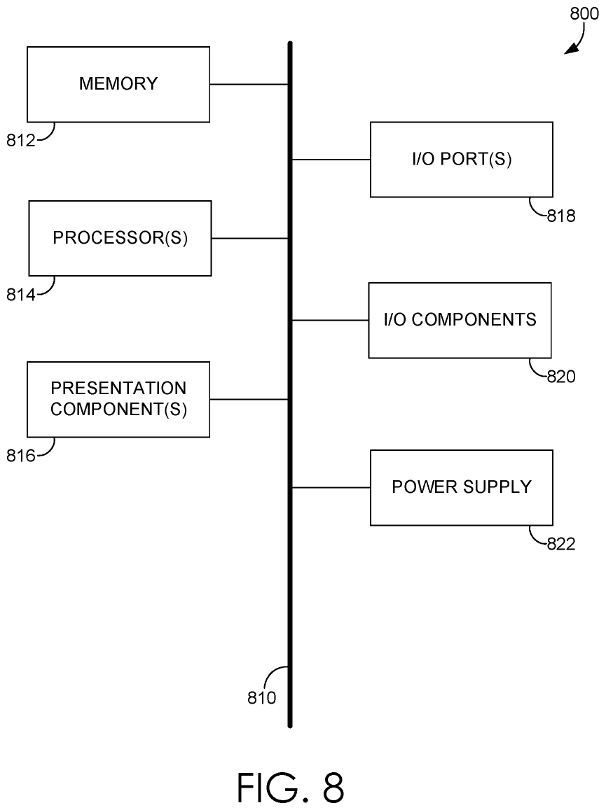

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a request associated with a diagnosis code of a vehicle associated with an item listing system;
based on the request, accessing code lookup data associated with a generative AI model, the code lookup data comprising code interpretation data and recommendation data associated with the diagnosis code, the generative AI model is associated with code lookup training operations and a code lookup data structure that support providing automotive diagnosis code guidance in the item listing system; and
communicating the code lookup data to cause display of the code lookup data via an item listing system client.

2. The system of claim 1, further comprising a generative AI code lookup engine that uses the generative AI model to generate the code lookup data comprising diagnosis code meaning, estimated repair cost, estimated cost, one or more recommended items for a code lookup interface for presenting instances of code lookup data for requests processed using the generative AI presentation engine.

3. The system of claim 1, further comprising a generative AI code lookup engine that is associated with a machine learning engine, the machine learning engine is associated with training the generative AI model that supports image generation and text generation for instances of code lookup data.

4. The system of claim 1, wherein the code lookup training operations support training generative AI models based on training data comprising user data, automotive data, image data, text data and item listing interfaces data, wherein the code lookup training operations support generating instances of code lookup data for a plurality of item listing interfaces of the item listing system.

5. The system of claim 1, wherein the code lookup data structure is associated with code lookup logic that includes instructions for providing the code lookup data including diagnosis code meaning, estimated repair cost, estimated cost, one or more recommended items to a code lookup interface.

6. The system of claim 1, wherein code lookup training operations are based on one or more prompt templates comprising structured input queries or instructions designed to train or instruct the generative AI model to generate instances of code lookup data.

7. The system of claim 6, wherein a prompt template comprises a plurality of code lookup data categories including two or more of the following Diagnosis Trouble Code (DTC), additional vehicle information, and historical automotive context.

8. The system of claim 1, wherein the code lookup data comprises two or more of the following: a non-generative AI data element, a generative AI data element, and a generative AI item listing interface element.

9. The system of claim 1, the operations further comprising:
communicating a request instance associated with a diagnosis code of a vehicle associated with a user;
based on communicating the request associated with the user, accessing an instance of code lookup data associated with user data of the user, the instance of code lookup data is associated with a code lookup interface; and
causing display of the instance of code lookup data on the code lookup interface.

10. The system of claim 9, the operations further comprising:
accessing a training dataset associated with training an instance of a generative AI model for an item listing system;
executing code lookup training operations on the training dataset to generate the instance of the generative AI model; and
deploying the instance of the generative AI model to support generating instances of code lookup data in the item listing system.

11. One or more computer-storage media having computer-executable instructions embodied thereon that, when executed by a computing system having a processor and memory, cause the processor to perform operations, the operations comprising:
communicating a request associated with a diagnosis code of a vehicle associated with a user of an item listing system;
based on communicating the request, accessing code lookup data associated with a generative artificial intelligence (AI) model, the code lookup data comprising code interpretation data and recommendation data associated with the diagnosis code, the generative AI model is associated with code lookup training operations and a code lookup data structure that support providing automotive diagnosis code guidance in the item listing system; and
causing display of the code lookup data on an item listing system client.

12. The media of claim 11, wherein the generative AI model is associated with a generative AI code lookup engine that uses the generative AI model to generate the code lookup data comprising diagnosis code meaning, estimated repair cost, estimated cost, one or more recommended items for a code lookup interface for presenting instances of code lookup data for requests processed using the generative AI presentation engine.

13. The media of claim 11, wherein the code lookup training operations support training generative AI models based on training data comprising user data, automotive data, image data, text data and item listing interfaces data, wherein the code lookup training operations support generating instances of code lookup data for a plurality of item listing interfaces of the item listing system.

14. The media of claim 11, wherein the code lookup data structure is associated with code lookup logic that includes instructions for providing the code lookup data including diagnosis code meaning, estimated repair cost, estimated cost, one or more recommended items to a code lookup interface.

15. The media of claim 11, wherein the code lookup data comprises two or more of the following: a non-generative AI data element, a generative AI data element, and a generative AI item listing interface element.

16. A computer-implemented method, the method comprising:
accessing a training dataset associated with training a generative AI model for an item listing system;
executing code lookup training operations on the training dataset to generate the generative AI model, the generative AI model is associated with code lookup training operations and a code lookup data structure that support providing automotive diagnosis code guidance in the item listing system; and
deploying the generative AI model to support generating code lookup data in the item listing system.

17. The method of claim 16, wherein the generative AI model is associated with a generative AI code lookup engine that uses the generative AI model to generate the code lookup data comprising diagnosis code meaning, estimated repair cost, estimated cost, one or more recommended items for a code lookup interface for presenting instances of code lookup data for requests processed using the generative AI presentation engine.

18. The method of claim 16, further comprising a generative AI code lookup engine that is associated with a machine learning engine, the machine learning engine is associated with training the generative AI model that supports image generation and text generation for instances of code lookup data.

19. The method of claim 16, wherein the code lookup training operations support training generative AI models based on training data comprising user data, automotive data, image data, text data and item listing interfaces data, wherein the code lookup training operations support generating instances of code lookup data for a plurality of item listing interfaces of the item listing system.

20. The method of claim 16, wherein the code lookup data structure is associated with code lookup logic that includes instructions for providing the code lookup data including diagnosis code meaning, estimated repair cost, estimated cost, one or more recommended items to a code lookup interface.
